(19) United States
(12) Patent Application Publication
(10) Pub. No.: US 2020/0134675 A1
(43) Pub. Date: Apr. 30, 2020

(54) PERSONALIZATION OF MESSAGES BY ASSESSING THE EFFECTIVENESS OF MESSAGES BASED ON MESSAGE OUTCOMES

(71) Applicant: Microsoft Technology Licensing, LLC, Redmond, WA (US)

(72) Inventors: Claire H. SISSON, Redmond, WA (US); Diego F. MARTINEZ DIAZ, Bellevue, WA (US); Venkat Pradeep CHILAKAMARRI, Seattle, WA (US); Meera A. KULKARNI, Redmond, WA (US); FNU Om KRISHNA, Redmond, WA (US); Kiran Kumar DOWLURU, Bellevue, WA (US); Philip RUEKER, Redmond, WA (US); Vlad RISCUTIA, Redmond, WA (US); Harish KASINA, Redmond, WA (US); Bharath VENKATESH, Bothell, WA (US)

(21) Appl. No.: 16/257,727

(22) Filed: Jan. 25, 2019

Related U.S. Application Data
(60) Provisional application No. 62/752,983, filed on Oct. 30, 2018.

(51) Int. Cl. G06Q 30/02; H04L 12/58

(52) U.S. Cl. CPC G06Q 30/0271; H04L 51/02; G06Q 30/0246

(57) ABSTRACT

Data is stored that defines a user lifecycle phase and a desired outcome for the user lifecycle phase. Metrics are computed for evaluating the individual effectiveness of each of the messages in a set of messages. Personalization rules can be generated for a particular user that are based on the computed metrics and attributes associated with the particular user. The personalization rules are rules for selecting messages from the set of messages for presentation to the particular user. The personalization rules can be provided to a computing device associated with the particular user. The computing device can utilize the personalization rules to select a message from the set of messages and present the selected message to the user.

### CROSS-REFERENCE TO RELATED APPLICATIONS

This application claims the benefit of U.S. Provisional Patent Application No. 62/752,983, entitled “Personalization of Messages By Assessing The Effectiveness of Messages Based on Message Outcomes,” which was filed on Oct. 30, 2018, and which is expressly incorporated herein by reference in its entirety.

### BACKGROUND

Many types of software are provided via a subscription license model, which is sometimes referred to as a “term license.” For example, desktop and mobile application programs, web sites, and other types of software products can be provided to a user as long as the user maintains a subscription to the product. The user will be prohibited from using the software product if the user does not renew (i.e. cancels) their subscription to the product at the end of their subscription term (e.g. a month or a year).

Customer retention poses a significant challenge to providers of software via a subscription license model. Software providers commonly utilize many different mechanism in order to maximize the likelihood that customers will renew their subscriptions at the end of their subscription terms. One such mechanism involves regularly presenting messages to subscribers that convey information regarding aspects of the software. For instance, messages might be presented to subscribers that identify various features of the software. Messages such as these are typically written to convey a value proposition for the software in an attempt to maximize the likelihood that the customer will renew their subscription at the end of its term.

Messages such as those described above can be provided to subscribers of subscription software using many different communication channels. For instance, applications and operating systems can present messages to subscribers via various and sometimes numerous in-application programmable messaging surfaces. Messages can also be provided to subscribers via traditional communications channels, such as electronic mail messages. Communication channels such as those described above are, however, most suitable for presenting one-off messages to subscribers, and are not generally suited for having a coherent and efficient ongoing conversation with subscribers.

Other factors can also contribute to an excessive number of messages being provided to subscribers. For instance, one product group within a subscription provider's organization might transmit an email message to subscribers describing a particular feature of an application. Another product group within the same organization might cause a message regarding a different feature of the application to be presented to subscribers via an in-application messaging surface. As a result, subscribers can be bombarded with a large volume of messages, some or many of which might be irrelevant to the subscribers or might even be duplicative. For instance, subscribers might receive messages describing product features that they are not interested in or messages that duplicate content presented in previous messages.

Presenting too many or irrelevant messages to subscribers in the manner described above can result in customers having a negative experience with a subscription software product. As a result, these customers might be unlikely to renew their subscriptions to the software product at the end of their subscription terms. Presenting too many or irrelevant messages to subscribers in the manner described above can also result in the utilization of computing resources unnecessarily. For example, the creation, storage, and transmission of irrelevant or excessive messages to subscribers can unnecessarily utilize processor cycles, memory, energy, mass storage, and network bandwidth. Unnecessary utilization of computing resources such as these can be significant, particularly where messages are provided to a large number of subscribers of a subscription software product.

It is with respect to these and other technical challenges that the disclosure made herein is presented.

### SUMMARY

Technologies are disclosed herein for the personalization of messages presented to users that have been selected based upon message outcomes. Through implementations of the disclosed technologies, computing resources can be conserved by selecting messages for presentation to a user from a group of messages that have a highest probability of achieving a desired outcome for a user lifecycle phase and, potentially, for the messages themselves. In particular, processor cycles, memory, energy, mass storage, and network bandwidth might be conserved through implementations of the disclosed technologies.

Presenting messages that have the highest probability of achieving a desired outcome for the messages and for a user lifecycle phase can also increase the likelihood that software subscribers will renew their subscriptions at the end of their subscription terms. Personalized messages that have been selected in the disclosed manner can also enable users to achieve more with a software product by enabling focused feature discovery enabled by more precise messaging. This can also reduce the annoyance caused to users by the presentation of excessive or irrelevant messages. Other technical benefits not specifically mentioned herein can also be realized through implementations of the disclosed subject matter.

In order to realize the technical benefits mentioned briefly above, data is stored that defines a user lifecycle phase and a desired outcome for the user lifecycle phase. Metrics are computed for evaluating the individual effectiveness of each of the messages in a set of messages. The metrics can include a lifecycle outcome metric for each of the messages that defines a percentage of a group of users to which a message in the group of messages was shown, and for which the desired outcome was achieved at the end of the user lifecycle phase for the users. The metrics can also include a message effectiveness metric for each of the messages. The message effectiveness metric defines a number of times a message had to be presented to users in the group of users to achieve a desired outcome for the message during a particular user lifecycle phase.

Personalization rules can also be generated for a particular user that are based on the computed metrics and attributes associated with the particular user. The personalization rules can be used to select messages from a group of messages that are eligible for presentation to the particular user. The personalization rules can be provided to a computing device associated with the user. The computing device can utilize the personalization rules to select a message from the group of messages and present the selected message to the user.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computing architecture diagram that shows aspects of a message orchestration system capable of prioritized presentation of messages based upon a desired outcome for a user lifecycle phase;

FIG. 2 shows aspects of a user lifecycle model utilized by the message orchestration system of FIGS. 1 and 3 and the message personalization system of FIGS. 5 and 6;

FIG. 3 is a computing architecture diagram that shows additional aspects of the configuration and operation of the message orchestration system shown in FIG. 1;

FIG. 4 is a flow diagram showing a routine that illustrates aspects of the operation of the message orchestration system described with reference to FIGS. 1-3;

FIG. 5 is a computing architecture diagram that shows aspects of the configuration and operation of a message personalization system configured for presenting messages to users that have been selected based upon message outcomes;

FIG. 6 is a computing architecture diagram that shows additional aspects of the configuration and operation of the message personalization system shown in FIG. 5;

FIG. 7 is a flow diagram showing a routine that illustrates aspects of the operation of the message personalization system described with reference to FIGS. 5 and 6;

FIG. 8 is a computer architecture diagram showing an illustrative computer hardware and software architecture for a computing device that can implement aspects of the technologies presented herein; and

FIG. 9 is a network diagram illustrating a distributed computing environment in which aspects of the disclosed technologies can be implemented.

### DETAILED DESCRIPTION

The following detailed description is directed to technologies for the personalization of messages presented to users that have been selected based upon message outcomes. As discussed briefly above, processor cycles, memory, energy, mass storage, and network bandwidth might be conserved through implementations of the disclosed technologies. Other technical benefits not specifically mentioned herein can also be realized through implementations of the disclosed subject matter.

While the subject matter described herein is presented in the general context of a desktop or server computer, those skilled in the art will recognize that other implementations can be performed in combination with other types of computing systems and modules. Those skilled in the art will also appreciate that the subject matter described herein can be practiced with other computer system configurations, including hand-held devices, multiprocessor systems, microprocessor-based or programmable consumer electronics, computing or processing systems embedded in devices (such as wearable computing devices, automobiles, home automation etc.), minicomputers, mainframe computers, and the like.

In the following detailed description, references are made to the accompanying drawings that form a part hereof, and which are shown by way of illustration specific configurations or examples. Referring now to the drawings, in which like numerals represent like elements throughout the several FIGS., technologies for prioritized presentation of messages based upon a desired outcome for a user lifecycle phase will be described.

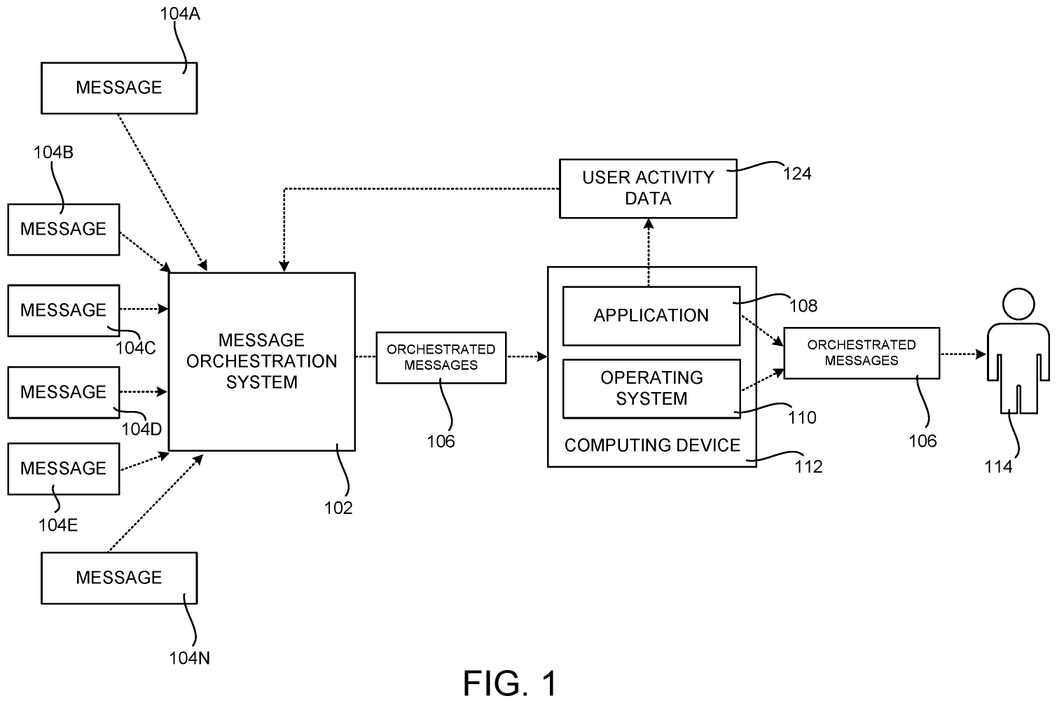

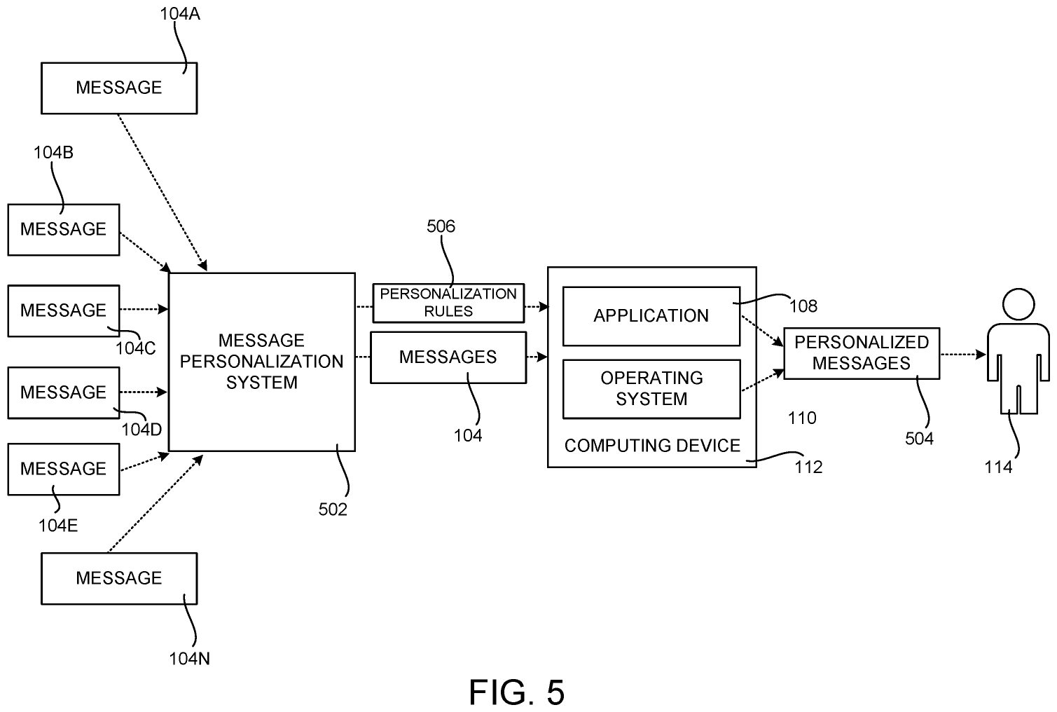

FIG. 1 is a computing architecture diagram that shows aspects of a message orchestration system 102 capable of presentation of messages 104 based upon a desired outcome for a user lifecycle phase and other data. As will be described in greater detail below with regard to FIGS. 5-7, the technologies disclosed herein for the personalization of messages presented to users that have been selected based upon message outcomes can be implemented in conjunction with the message orchestration system 102. It is to be appreciated, however, that the technologies for message personalization can be implemented in conjunction with other types of systems and/or in a standalone configuration in other implementations.

As illustrated in FIG. 1, the message orchestration system 102 can receive messages 104A-104N (which might be referred to herein collectively as the “messages 104” or individually as “a message 104”) from a variety of sources. For example, different product or feature groups within an organization might submit messages 104 to the message orchestration system 102. As a result, there might be hundreds or even thousands of messages 104 that the different teams would like to send to the user 114. As discussed above, this quantity of messages can overwhelm or annoy users and also consume computing resources unnecessarily.

The messages 104 can include various types of content including, but not limited to, content directing a user 114 toward various features of an application 108 or content instructing the user 114 on the use of a feature of the application 108. The messages 104 can include other types of content in other configurations.

As also illustrated in FIG. 1, the message orchestration system 102 can select messages (referred to herein as “orchestrated messages 106”), for presentation to a user 114. The orchestrated messages 106 can then be provided to a computing device 112 for presentation to the user 114.

The orchestrated messages 106 can be presented to the user 114 through an appropriate user interface (“UI”) provided by the application 108 or an operating system 110. For example, and without limitation, the application 108 can present the orchestrated messages 106 to the user in an in-application programmable messaging surface. Messages can also be presented to the user 114 in other ways including, but not limited to, an electronic mail client application.

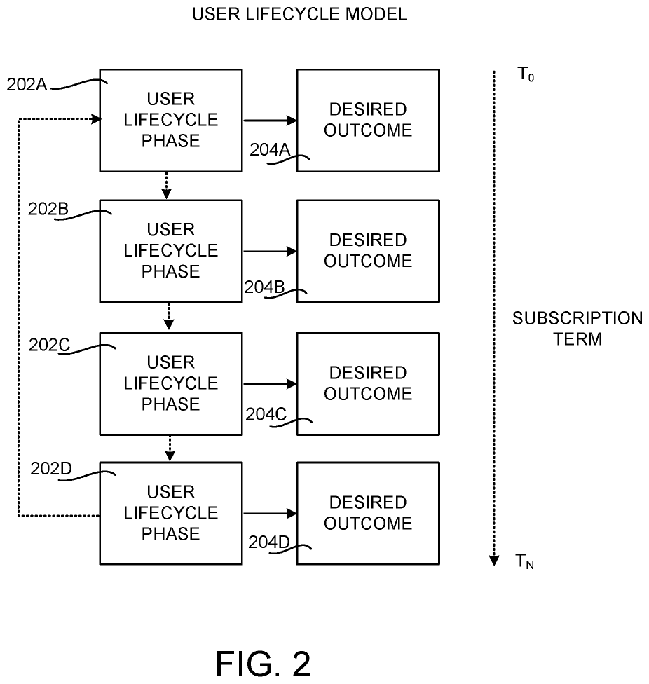

As will be described in greater detail below, the messages 104 can be orchestrated based upon a desired outcome for a current user lifecycle phase for the user 114. Details regarding a user lifecycle model defining various user lifecycle phases and corresponding desired outcomes will be described below with regard to FIG. 2.

The messages 104 can also be orchestrated based upon other factors including, but not limited to, user activity data 124 that describes user activity 114 with an application 108 prior to receiving a message 104, while viewing a message 104, and after viewing the message 104. The user activity data 124 can be collected on the computing device 112 with the user's 114 express consent and fed back into the message orchestration system 102 for use in improving the relevance of messages 104 sent to the user 114 in the future. Message orchestration can be based on other factors, some of which are described below.

FIG. 2 shows aspects of a user lifecycle model utilized by the message orchestration system 102 of FIG. 1 for orchestrated presentation of messages 104 based upon a desired outcome for a user lifecycle phase. As shown in FIG. 2 and described briefly above, the user lifecycle model divides the term of a subscription, such as a subscription to the application 108, into two or more user lifecycle phases 202. In the example shown in FIG. 2, for instance, the subscription term has been divided into four user lifecycle phases 202A-202D. The term of a subscription can be divided into another number of user lifecycle phases 202 in other configurations.

Each user lifecycle phase 202 represents a period of time during a subscription term. In the example shown in FIG. 2, for instance, the user lifecycle phase 202A might correspond to days 1-14 of a one year subscription. The user lifecycle phase 202B might correspond to days 15-60 of the one year subscription, the user lifecycle phase 202C might correspond to days 61-351 of the one year subscription, and the user lifecycle phase 202D might correspond to days 352-365 of the one year subscription. After the last user lifecycle phase 202D in a user lifecycle model has completed, the model returns to the first user lifecycle phase 202A in the model. The user lifecycle phases 202 can be represented as data in a data structure referred to below as the user lifecycle phase definitions 316.

As illustrated in FIG. 2, a desired outcome 204 is also defined for each user lifecycle phase 202. The desired outcomes 204 define a desired action, or actions, for a user 114 to take before the end of each user lifecycle phase 202. For example, a desired outcome 204 for a user lifecycle phase 202 might be that a user begin using a storage service to store files created with or accessible by the application 108. As another example, the desired outcome for the final user lifecycle phase 202D in the user lifecycle model might be that a user renews their subscription to the application 108 for another subscription term. The desired outcomes 204 for the user lifecycle phases 202 can change over time. Data describing the desired outcomes 204 for the user lifecycle phases 202 can be stored in a data structure referred to below as the desired outcome definitions 318.

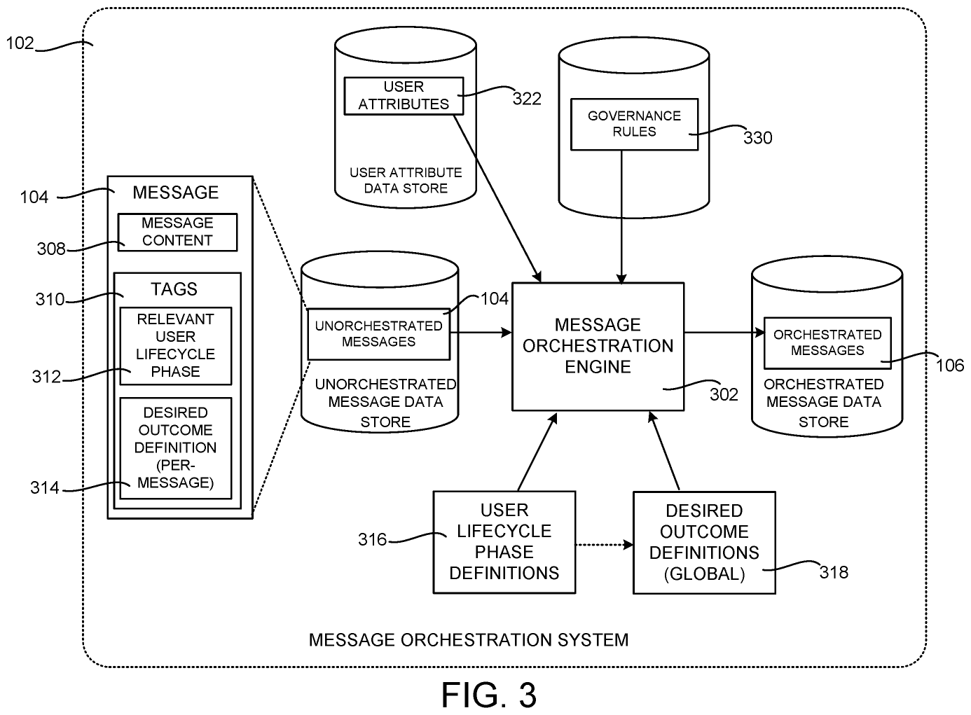

FIG. 3 is a computing architecture diagram that shows additional aspects of the configuration and operation of the message orchestration system 102 shown in FIG. 1. As shown in FIG. 3, the message orchestration system 102 includes a message orchestration engine 302. The message orchestration engine 302 is a software or hardware component that receives messages 104 and orchestrates the delivery of some or all of the messages 104 to a particular user 114. The message orchestration engine 302 can select particular messages 106 for presentation to a particular user 114 at a particular time based, at least in part, upon the desired outcome for a particular user 114 for the user lifecycle phase that the user 114 is currently in. As discussed above, the message orchestration engine 302 can also select messages 106 for presentation to a particular user at a particular time based upon based upon one or more governance rules (described below), user attributes, user activity, seasonality, and/or other factors. Messages 104 that have not been selected for presentation to the user 114 at a particular time might be shown to the user 114 later or might not be shown to the user 114 at all.

In order to provide the functionality described above, messages 104 can be submitted to the message orchestration system 102 from a variety of sources. The messages 104 include the message content 308 that is to be presented to users 114. The messages 104 also define a relevant user lifecycle phase 312 that the message is associated with. Messages 104 eligible to be transmitted to each user 114 can be identified by comparing the relevant user lifecycle phase 312 specified by the messages 104 to the current user lifecycle phase 312 for each user 114. Only messages 104 having a relevant user lifecycle phase 312 might be transmitted to users 114 currently in the same user lifecycle phase.

As shown in FIG. 3, the messages 104 can also specify a per-message desired outcome definition 314. The per-message desired outcome definition 314 defines a desired action, or actions, for a user to take in response to receiving a particular message. For instance, a message 104 might provide information to a user 114 about a particular feature of the application 108. The per-message desired outcome for that message 104 might be that the user access or utilize the feature. Other types of per-message desired outcomes can be specified.

In order to identify which, if any, of the messages 104 that are to be presented to a particular user 114, the message orchestration engine 302 might first determine the current user lifecycle phase 202 for the user (i.e. the user lifecycle phase 202 that the user 114 is currently in). The current user lifecycle phase 202 for the user 114 might be stored as user attributes 322 in an appropriate data store. The user attributes 322 can also include other information about a user 114 such as, but not limited to, information describing a user's interests, data describing a user's utilization of the application 108, data describing a user's utilization of previous versions of the application 108, a user's interacting with an operating system, other applications, other network services, and/or other types of information. As mentioned above, this information is collected from the user 114 with their express consent.

The message orchestration engine 302 also identifies the corresponding desired outcome 204 for the current user lifecycle phase 202. The message orchestration engine 302 can then identify the messages 104 that are eligible to be shown to the particular user 114 by comparing the relevant user lifecycle phase 312 of the messages 104 to the current user lifecycle phase 202 of the user 114. As discussed above, only messages 104 specifying a relevant user lifecycle phase 312 that is the same as the user's current lifecycle phase 202 might be considered eligible for presentation to the user 114.

The message orchestration engine 302 can then select one or more of the messages 104 that are eligible to be shown to the particular user 114 at the particular time. The selection of the messages can be made based on some or all of the data described above, including the desired outcome of the current user lifecycle phase 202 of the user 114. Messages 104 that are more likely to advance the desired outcome of the current user lifecycle phase 202 may be more likely to be presented to the user. Messages 104 that are less likely to advance the desired outcome of the current user lifecycle phase 202 of the user 114 are less likely to be presented to the user.

The message, or messages, to be shown to the user 114 (i.e. the orchestrated messages 106) are then presented to the user 114 in the manner described above. As also discussed above, messages 104 having a lower priority (e.g. messages 104 not directly relevant to successfully accomplishing the desired outcome for the user's current lifecycle phase) might be provided to the user 114 at a later time or not provided to the user 114 at all. In this manner, presentation of the messages 104 is tailored to each user 114. As a result, users are less likely to receive messages 104 that are irrelevant to their interests or particular use of the application 108.

In some configurations, the messages 104 that have a higher probability of causing a specific desired outcome can be identified through experimentation over time. For example, messages 104 might be orchestrated in a particular order and transmitted to a user 114. A determination might then be made as to whether the messages 104 resulted in the desired outcome. This process can then be repeated using messages orchestrated in a different order until the system converges on a personalized model for each user 104.

As shown in FIG. 3, the message orchestration engine 302 can also utilize governance rules 330 in the selection of messages 104 to be shown to a particular user 114. The governance rules 330 can be defined by a user or machine-generated (e.g. by using machine learning techniques).

The governance rules 330 define rules that can be applied to the messages 104 to determine those messages that are eligible to be presented to a particular user 114 at a particular point in time. For example, a governance rule 330 might specify that only messages 104 having content 308 relating to Halloween are to be presented to a user 114 during the month of October. Messages not having content 308 relating to Halloween will, therefore, not be eligible for presentation during that time period. Governance rules 330 based upon factors other than seasonality can also be defined. The governance rules 330 can also be updated based upon the user activity data 124 collected from a user 114 (e.g. data describing that actions that a user 114 took before receiving a message, while viewing a message, and after viewing a message).

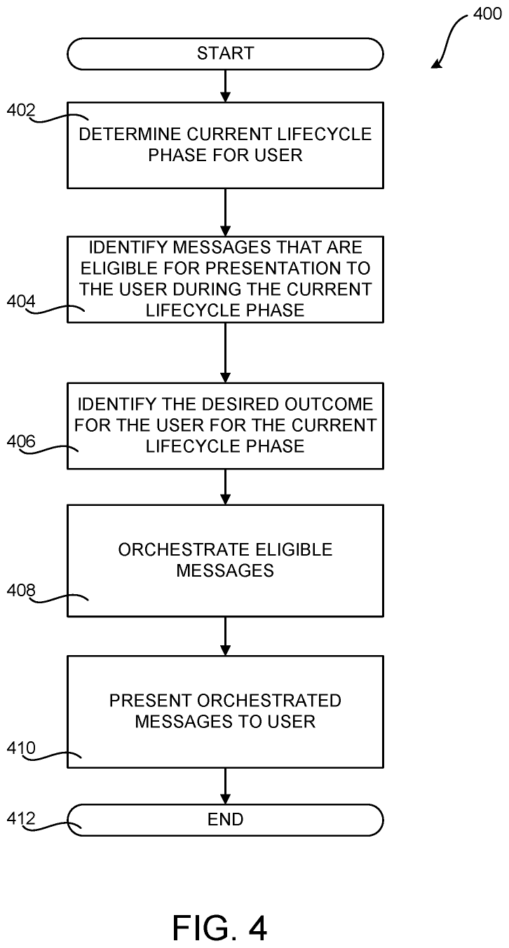

FIG. 4 is a flow diagram showing a routine 400 that illustrates aspects of the operation of the message orchestration system 102 described with reference to FIGS. 1-3, according to one particular configuration. It should be appreciated that the logical operations described herein with regard to FIG. 4, and the other FIGS., can be implemented (1) as a sequence of computer implemented acts or program modules running on a computing device and/or (2) as interconnected machine logic circuits or circuit modules within a computing device.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein.

The routine 400 begins at operation 402, where the message orchestration engine 302 determines the current user lifecycle phase 202 for a user (i.e. the user lifecycle phase 202 that the user 114 is currently in). As discussed above, the current user lifecycle phase 202 might be specified by the user attributes 322.

From operation 402, the routine 400 proceeds to operation 404, where the message orchestration engine 302 identifies the messages 104 that are eligible to be shown to the particular user 114 by comparing the relevant user lifecycle phase 312 of the messages 104 to the current user lifecycle phase 202 of the user 114. As discussed above, only messages 104 specifying a relevant user lifecycle phase 312 that is the same as the user's current lifecycle phase 202 are eligible for presentation to the user 114.

From operation 404, the routine 400 proceeds to operation 406, where the message orchestration engine 302 identifies the desired outcome 204 for the current user lifecycle phase 202. The routine 400 then proceeds to operation 408, where the message orchestration engine 302 selects messages from the eligible messages for presentation to a particular user at a particular time. As discussed above, messages can be selected based, at least in part, upon the desired outcome of the current user lifecycle phase 202 of the user 114. In particular, messages 104 that are more likely to advance the desired outcome of the current user lifecycle phase 202 of the user 114 may be given higher priority for presentation. Messages 104 that are less likely to advance the desired outcome of the current user lifecycle phase 202 of the user 114 may be given a lower priority or excluded from consideration at the particular point in time.

From operation 408, the routine 400 proceeds to operation 410, where the messages 104 eligible to be shown to the user 114 (i.e. the orchestrated messages 106) are then presented to the user 114 in the manner described above. In this manner, presentation of the messages 104 is tailored to each user 114 and, as a result, users 114 are less likely to receive messages 104 that are irrelevant to their interests or particular use of the application 108. The routine 400 then proceeds from operation 410 to operation 412, where it ends.

FIG. 5 is a computing architecture diagram that shows aspects of the configuration and operation of a message personalization system 502 configured for presenting messages 104 to users 114 that have been selected based upon message outcomes. As discussed briefly above, the message personalization system 502 is implemented in conjunction with the message orchestration system 102 in some configurations. It is to be appreciated, however, that the message personalization system 502 can be implemented in conjunction with other types of systems and/or in a standalone configuration in other implementations.

As illustrated in FIG. 5, the message orchestration system 102 can receive messages 104 from a variety of sources. As discussed above, for instance, different product or feature groups within an organization might submit messages 104 to the message orchestration system 102. As a result, there might be hundreds or even thousands of messages 104 that the different teams would like to send to the user 114. As discussed above, this quantity of messages can overwhelm users and also consume computing resources unnecessarily, particularly if the messages presented to the users are not relevant to the users.

As also discussed above, the messages 104 can include various types of content including, but not limited to, content directing a user 114 toward various features of an application 108 or content instructing the user 114 on the use of a feature of the application 108. The messages 104 can include other types of content in other configurations.

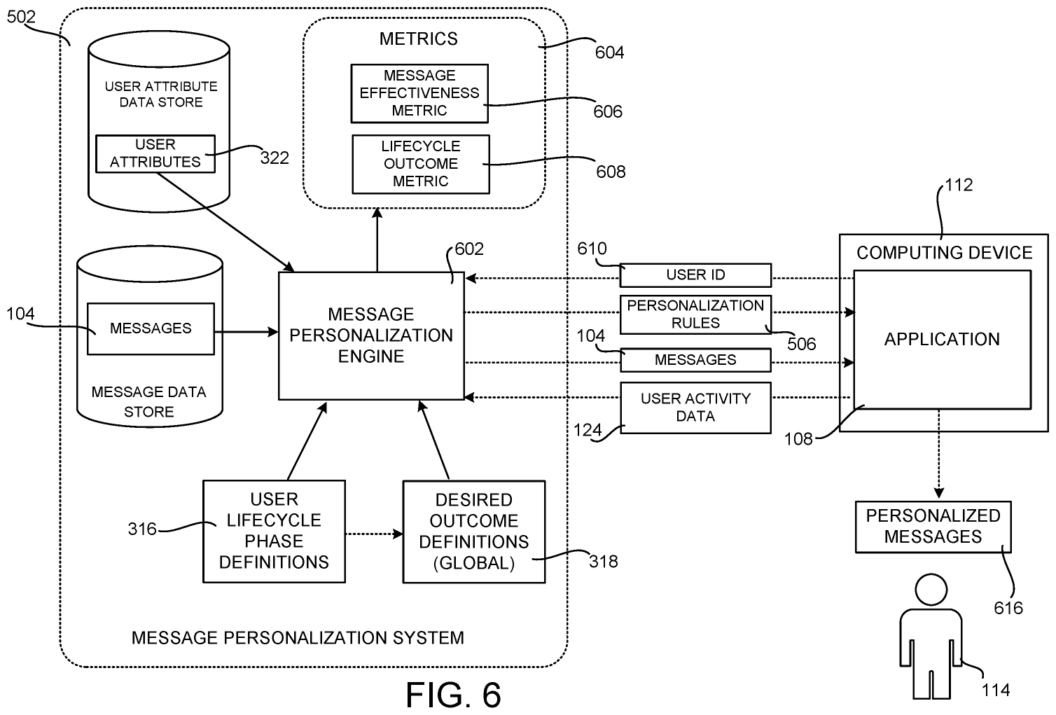

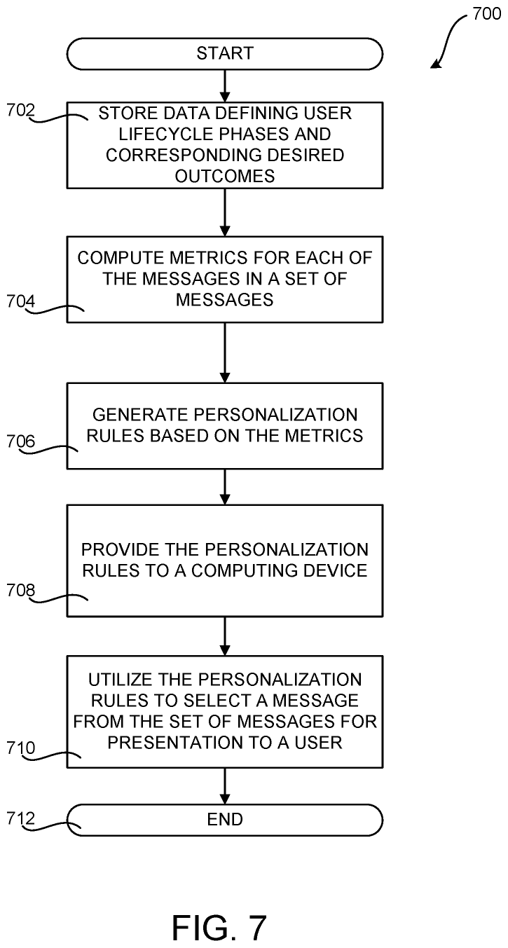

In one configuration, the message personalization system 502 generates personalization rules 506 for a particular user 114 that are based on computed metrics and attributes associated with the particular user 114. The personalization rules 506 are rules for selecting individual messages 104 from the set of available messages 104 for presentation to a particular user 114. As shown in FIG. 5, the personalization rules 506 can be provided to a computing device 112 associated with the particular user 114. The computing device 112 can utilize the personalization rules 506 to select a message 104 from the set of available messages 104 and present the selected message 104 to the user 114. Additional details regarding the generation and utilization of the presentation rules 506 are provided below with regard to FIGS. 6 and 7.

The personalized messages 504 can be presented to the user 114 through an appropriate UI provided by the application 108, an operating system 110, or another component. For example, and without limitation, the application 108 can present the personalized messages 504 to the user 114 in an in-application programmable messaging surface. The personalized messages 504 can also be presented to the user 114 in other ways including, but not limited to, an electronic mail client application.

FIG. 6 is a computing architecture diagram that shows additional aspects of the configuration and operation of the message personalization system 502 shown in FIG. 5. As shown in FIG. 6, the message personalization system 502 includes a message personalization engine 602 in one configuration. The message personalization engine 602 is a hardware or software component configured to generate personalization rules 506.

As discussed above, the personalization rules 506 can be utilized to select an individual message 104 from the set of available messages 104 for presentation to a particular user 114. The selected message 104 can then be presented to the particular user 114. In the example shown in FIG. 6, the application 108 utilizes the personalization rules 506 to select personalized messages 616 for the user 114 and presents the personalized messages 616 to the user 114. Other components can perform these functions in other configurations.

The message personalization engine 602 can generate metrics 604 for evaluating the individual effectiveness of each of the messages 104 in the set of available messages in order to generate the personalization rules 506. For example, and without limitation, the message personalization engine 602 can generate a lifecycle outcome metric 608 for each of the messages 104. The lifecycle outcome metric 608 defines a percentage of a group of users 114 to which a message 104 in the set of available messages was shown, and for which the desired outcome 204 was achieved at the end of the user lifecycle phase 202 for the users 114.

The message personalization engine 602 can also compute a message effectiveness metric 606 for each of the available messages. 104 The message effectiveness metric 606 defines a number of times a particular message 104 had to be presented to users 114 in a group of users to achieve a desired outcome (i.e. the desired outcome specified in the per-message desired outcome definition 314 in the message 104) for the message 114 during a user lifecycle phase 202. It is to be appreciated that other types of metrics 604 can be computed in other configurations and utilized to generate the personalization rules 506 in other configurations.

The message personalization engine 602 can generate personalization rules 506 for a particular user 114 based on the computed metrics 604 and attributes 322 associated with the particular user 144. As discussed above, the user attributes 322 can include information about a user 114 such as, but not limited to, the current user lifecycle phase 202 for the user, information describing a user's interests, data describing a user's utilization of the application 108, data describing a user's utilization of previous versions of the application 108, data describing a user's interaction with messages 104 presented to the user, and/or other types of information.

In one particular configuration, user attributes 322 are generated through the collection of data from the user 114 regarding the user's interaction with the application 108 and the messages 104 that have been presented to the user. To enable this functionality, the application 108, or another component, can transmit a user ID 610 associated with the particular user 114 to the message personalization engine 602.

Using the user ID 610, the message personalization engine 602 can obtain the user attributes 322 for the user 114. The message personalization engine 602 can then compute the personalization rules 506 for the user 114 in the manner described above. The message personalization rules 506 and the messages 104 can then be provided to the application 108 or other component on the computing device 112.

As discussed above, the application 108 or another component can utilize the personalization rules 506 for the user 114 to select a message 104 for presentation to the user 114. For example, the application 108 might select a message 104 that includes content informing the user 114 about the availability of a particular feature of the application 108 and present the selected message 104 to the user 114.

In response to viewing the selected message 104, the user 114 might take some sort of action. The application 108 can provide user activity data 614 describing the action taken by the user 114 following presentation of the selected message 104. For instance, continuing the example from above, if the application 108 presents a message 104 to the user 114 informing the user 114 about the availability of a particular feature of the application 108, the user 104 might select (e.g. click on) the message 104. In this event, user activity data 614 indicating that the message 104 was selected will be reported to the message personalization engine 602.

In a similar fashion, the user 104 might utilize the feature of the application 108 described by the message 104 responsive to viewing the message 104. In this case, the application 108 can transmit user activity data 614 to the message personalization engine 602 indicating that the user 114 utilized the feature. Other types of user activity can also be transmitted to the message personalization engine 602.

The user activity data 614 received by the message personalization engine 602 for a particular user 114 is stored in the user attributes 522. In this manner, the action that the user 114 took following the presentation of a message 114 (e.g. selecting the message, ignoring the message, deleting the message, or using an application feature identified by the message 114) can be utilized in the generation of the personalization rules 506 in the manner described above. Other types of data can also be utilized to generate the personalization rules 506 in other configurations.

FIG. 7 is a flow diagram showing a routine 700 that illustrates aspects of the operation of the message personalization system 502 described above with reference to FIGS. 5 and 6. The routine 700 begins at operation 702, where data defining the user lifecycle phases 202 and the desired outcomes 204 for each phase 202 are stored (e.g. the user lifecycle phase definitions 316 and the desired outcome definitions 318 shown in FIG. 3, respectively).

From operation 702, the routine 700 proceeds to operation 704, where the message personalization engine 602 computes the metrics 604 for the messages 104 that are available for presentation to users 114 in the manner described above. The routine 700 then proceeds to operation 706, where the message personalization engine 602 generates personalization rules 506 for a particular user 114 that are based on the metrics computed at operation 704 and user attributes 322 associated with the particular user 114.

The routine 700 then proceeds from operation 706 to operation 708, where the message personalization engine 602 provides the personalization rules 506 to a computing device 112 associated with the particular user 114. As discussed above, the computing device 112 can utilize the personalization rules 506 to select a message 104 from the set of available messages 104 and present the selected message 104 to the user 114. This occurs at operation 710. From operation 710, the routine 700 proceeds to operation 712, where it ends.

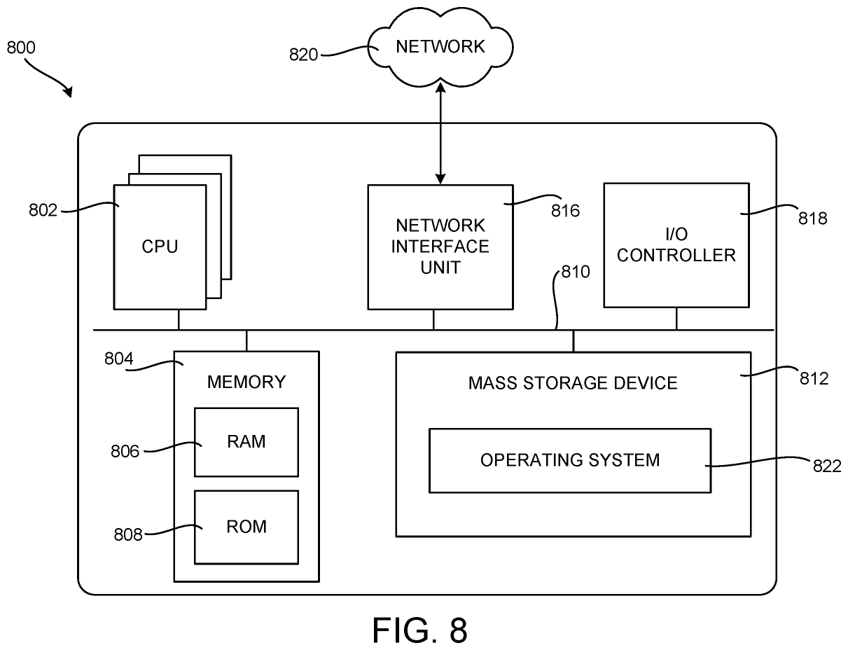

FIG. 8 is a computer architecture diagram showing an illustrative computer hardware and software architecture for a computing device that can implement the various technologies presented herein. In particular, the architecture illustrated in FIG. 8 can be utilized to implement a server computer, mobile phone, an e-reader, a smartphone, a desktop computer, an AR/VR device, a tablet computer, a laptop computer, or another type of computing device.

The computer 800 illustrated in FIG. 8 includes a central processing unit 802 (“CPU”), a system memory 804, including a random-access memory 806 (“RAM”) and a read-only memory (“ROM”) 808, and a system bus 810 that couples the memory 804 to the CPU 802. A basic input/output system (“BIOS” or “firmware”) containing the basic routines that help to transfer information between elements within the computer 800, such as during startup, can be stored in the ROM 808. The computer 800 further includes a mass storage device 812 for storing an operating system 822, application programs, and other types of programs. The mass storage device 812 can also be configured to store other types of programs and data.

The mass storage device 812 is connected to the CPU 802 through a mass storage controller (not shown) connected to the bus 810. The mass storage device 812 and its associated computer readable media provide non-volatile storage for the computer 800. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 800. For purposes of the claims, the phrase “computer storage medium,” and variations thereof, does not include waves or signals per se or communication media.

According to various configurations, the computer 800 can operate in a networked environment using logical connections to remote computers through a network such as the network 820. The computer 800 can connect to the network 820 through a network interface unit 816 connected to the bus 810. It should be appreciated that the network interface unit 816 can also be utilized to connect to other types of networks and remote computer systems. The computer 800 can also include an input/output controller 818 for receiving and processing input from a number of other devices, including a keyboard, mouse, touch input, an electronic stylus (not shown in FIG. 8), or a physical sensor such as a video camera. Similarly, the input/output controller 818 can provide output to a display screen or other type of output device (also not shown in FIG. 8).

It should be appreciated that the software components described herein, when loaded into the CPU 802 and executed, can transform the CPU 802 and the overall computer 800 from a general-purpose computing device into a special-purpose computing device customized to facilitate the functionality presented herein. The CPU 802 can be constructed from any number of transistors or other discrete circuit elements, which can individually or collectively assume any number of states. More specifically, the CPU 802 can operate as a finite-state machine, in response to executable instructions contained within the software modules disclosed herein. These computer-executable instructions can transform the CPU 802 by specifying how the CPU 802 transitions between states, thereby transforming the transistors or other discrete hardware elements constituting the CPU 802.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 800 in order to store and execute the software components presented herein. It also should be appreciated that the architecture shown in FIG. 8 for the computer 800, or a similar architecture, can be utilized to implement other types of computing devices, including hand-held computers, video game devices, embedded computer systems, mobile devices such as smartphones, tablets, and AR/VR devices, and other types of computing devices known to those skilled in the art. It is also contemplated that the computer 800 might not include all of the components shown in FIG. 8, can include other components that are not explicitly shown in FIG. 8, or can utilize an architecture completely different than that shown in FIG. 8.

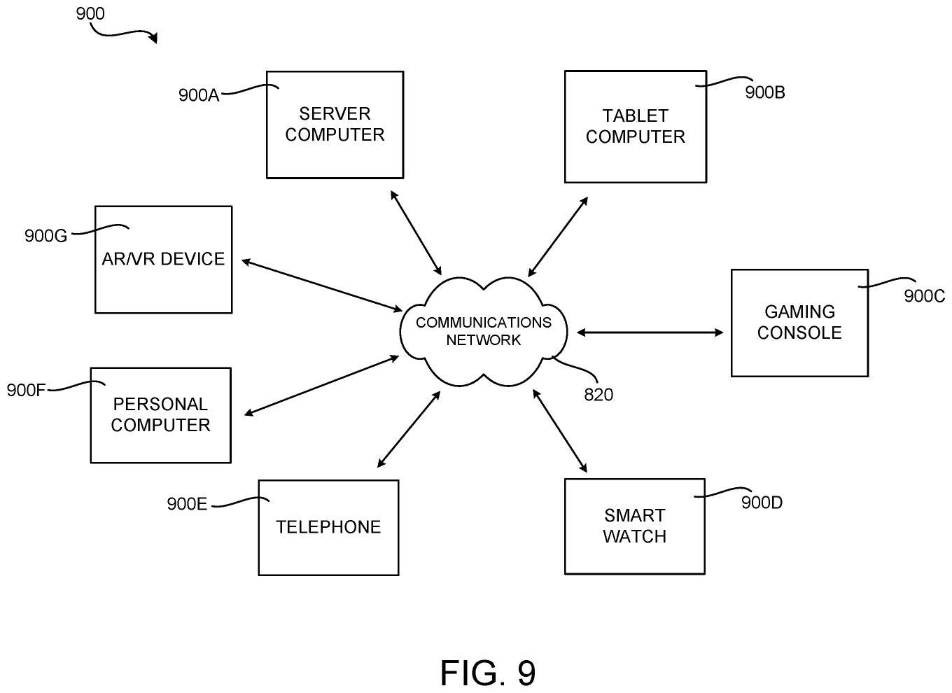

FIG. 9 is a network diagram illustrating a distributed network computing environment 900 in which aspects of the disclosed technologies can be implemented, according to various configurations presented herein. As shown in FIG. 9, one or more server computers 900A can be interconnected via a communications network 820 (which may be either of, or a combination of, a fixed-wire or wireless LAN, WAN, intranet, extranet, peer-to-peer network, virtual private network, the Internet, Bluetooth communications network, proprietary low voltage communications network, or other communications network) with a number of client computing devices such as, but not limited to, a tablet computer 900B, a gaming console 900C, a smart watch 900D, a telephone 900E, such as a smartphone, a personal computer 900F, and an AR/VR device 900G.

In a network environment in which the communications network 820 is the Internet, for example, the server computer 900A can be a dedicated server computer operable to process and communicate data to and from the client computing devices 900B-900G via any of a number of known protocols, such as, hypertext transfer protocol (“HTTP”), file transfer protocol (“FTP”), or simple object access protocol (“SOAP”). Additionally, the networked computing environment 900 can utilize various data security protocols such as secured socket layer (“SSL”) or pretty good privacy (“PGP”). Each of the client computing devices 900B-900G can be equipped with an operating system operable to support one or more computing applications or terminal sessions such as a web browser (not shown in FIG. 9), or other graphical user interface (not shown in FIG. 9), or a mobile desktop environment (not shown in FIG. 9) to gain access to the server computer 900A.

The server computer 900A can be communicatively coupled to other computing environments (not shown in FIG. 9) and receive data regarding a participating user's interactions/resource network. In an illustrative operation, a user (not shown in FIG. 9) may interact with a computing application running on a client computing device 900B-900G to obtain desired data and/or perform other computing applications.

The data and/or computing applications may be stored on the server 900A, or servers 900A, and communicated to cooperating users through the client computing devices 900B-900G over an exemplary communications network 820. A participating user (not shown in FIG. 9) may request access to specific data and applications housed in whole or in part on the server computer 900A. These data may be communicated between the client computing devices 900B-900G and the server computer 900A for processing and storage.

The server computer 900A can host computing applications, processes and applets for the generation, authentication, encryption, and communication of data and applications, and may cooperate with other server computing environments (not shown in FIG. 9), third party service providers (not shown in FIG. 9), network attached storage (“NAS”) and storage area networks (“SAN”) to realize application/data transactions.

It should be appreciated that the computing architecture shown in FIG. 8 and the distributed network computing environment shown in FIG. 9 have been simplified for ease of discussion. It should also be appreciated that the computing architecture and the distributed computing network can include and utilize many more computing components, devices, software programs, networking devices, and other components not specifically described herein.

The disclosure presented herein also encompasses the subject matter set forth in the following clauses:

Clause 1. A computer-implemented method, comprising: storing data defining a user lifecycle phase and a desired outcome for the user lifecycle phase; computing metrics for evaluating the effectiveness of each of a plurality of messages, the metrics comprising a lifecycle outcome metric and a message effectiveness metric for each of the plurality of messages; generating a plurality of personalization rules based on the computed metrics and one or more attributes associated with a user, the personalization rules defining rules for selecting messages from the plurality of messages for presentation to the user; and providing the plurality of personalization rules to a computing device associated with the user, wherein the computing device is configured to select a message of the plurality of messages for presentation to the user using the personalization rules, and present the selected message in a user interface.

Clause 2. The computer-implemented method of clause 1, wherein the lifecycle outcome metric defines a percentage of a group of users to which a message of the plurality of messages was shown and for which the desired outcome was achieved at the end of the user lifecycle phase.

Clause 3. The computer-implemented method of any of clauses 1-2, wherein for each of the plurality of messages, the message effectiveness metric defines a number of times a message of the plurality of messages had to be presented to a user of the group of users to achieve a desired outcome for the message during the user lifecycle phase.

Clause 4. The computer-implemented method of any of clauses 1-3, wherein the attributes comprise one or more of data describing a current user lifecycle phase for the user, data describing interests of the user, data describing utilization of an application by the user, data describing utilization of previous versions of the application by the user, or data describing interaction with messages presented to the user.

Clause 5. The computer-implemented method of any of clauses 1-4, wherein the attributes are generated by collecting data from the user indicating interaction with an application and interaction with messages previously presented to the user by the application.

Clause 6. The computer-implemented method of any of clauses 1-5, wherein the interaction with messages previously presented to the user comprises selecting the previous messages, ignoring the previous messages, deleting the previous messages, or using an application feature identified by the previous messages.

Clause 7. The computer-implemented method of any of clauses 1-6, wherein the plurality of messages comprises messages specifying a user lifecycle phase the same as a user lifecycle phase associated with the user.

Clause 8. The computer-implemented method of any of clauses 1-7, wherein the selected message comprises content identifying features of an application or content with instructions on the use of a feature of the application.

Clause 9. A computer-readable storage medium having computer-executable instructions stored thereupon which, when executed by a processor, cause the processor to: store data defining a user lifecycle phase and a desired outcome for the user lifecycle phase; compute metrics for evaluating the effectiveness of each of a plurality of messages, the metrics comprising a lifecycle outcome metric for each of the plurality of messages, the lifecycle outcome metric defining a percentage of a group of users to which a message of the plurality of messages was shown and for which the desired outcome was achieved at the end of the user lifecycle phase, and a message effectiveness metric for each of the plurality of messages, the message effectiveness metric defining a number of times a message of the plurality of messages had to be presented to a user of the group of users to achieve a desired outcome for the message during the user lifecycle phase; generate a plurality of personalization rules based on the computed metrics and one or more attributes associated with a particular user, the personalization rules defining rules for selecting messages from the plurality of messages for presentation to the particular user; and provide the plurality of personalization rules to a computing device, wherein the computing device is configured to utilize the personalization rules to select a message of the plurality of messages for presentation to the particular user, and present the selected message in a user interface.

Clause 10. The computer-readable storage medium of clause 9, wherein the attributes comprise one or more of data describing a current user lifecycle phase for the user, data describing interests of the user, data describing utilization of an application by the user, data describing utilization of previous versions of the application by the user, or data describing interaction with messages presented to the user.

Clause 11. The computer-readable storage medium of any of clauses 9-10, wherein the attributes are generated by collecting data from the user indicating interaction with an application and interaction with messages previously presented to the user by the application.

Clause 12. The computer-readable storage medium of any of clauses 9-11, wherein the interaction with messages previously presented to the user comprises selecting the previous messages, ignoring the previous messages, deleting the previous messages, or using an application feature identified by the previous messages.

Clause 13. The computer-readable storage medium of any of clauses 9-12, wherein the plurality of messages comprises messages specifying a user lifecycle phase the same as a user lifecycle phase associated with the user.

Clause 14. The computer-readable storage medium of any of clauses 9-13, wherein the selected message comprises content identifying features of an application or content with instructions on the use of a feature of the application.

Clause 15. A computing device, comprising: a processor; and a memory storing instructions executable by the processor to: store data defining a user lifecycle phase and a desired outcome for the user lifecycle phase; compute metrics for evaluating the effectiveness of each of a plurality of messages, the metrics comprising a lifecycle outcome metric for each of the plurality of messages, the lifecycle outcome metric defining a percentage of a group of users to which a message of the plurality of messages was shown and for which the desired outcome was achieved at the end of the user lifecycle phase, and a message effectiveness metric for each of the plurality of messages, the message effectiveness metric defining a number of times a message of the plurality of messages had to be presented to a user of the group of users to achieve a desired outcome for the message during the user lifecycle phase; generate a plurality of personalization rules based on the computed metrics and one or more attributes associated with a particular user, the personalization rules defining rules for selecting messages from the plurality of messages for presentation to the particular user; and provide the plurality of personalization rules to a second computing device, wherein the second computing device is configured to utilize the personalization rules to select a message of the plurality of messages for presentation to the particular user, and present the selected message.

Clause 16. The computing device of clause 15, wherein the attributes comprise one or more of data describing a current user lifecycle phase for the user, data describing interests of the user, data describing utilization of an application by the user, data describing utilization of previous versions of the application by the user, or data describing interaction with messages presented to the user.

Clause 17. The computing device of any of clauses 15-16, wherein the attributes are generated by collecting data from the user indicating interaction with an application and interaction with messages previously presented to the user by the application.

Clause 18. The computing device of any of clauses 15-17, wherein the interaction with messages previously presented to the user comprises selecting the previous messages, ignoring the previous messages, deleting the previous messages, or using an application feature identified by the previous messages.

Clause 19. The computing device of any of clauses 15-18, wherein the plurality of messages comprises messages specifying a user lifecycle phase the same as a user lifecycle phase associated with the user.

Clause 20. The computing device of any of clauses 15-19, wherein the selected message comprises content identifying features of an application or content with instructions on the use of a feature of the application.

Based on the foregoing, it should be appreciated that technologies for the personalization of messages presented to users that have been selected based upon message outcomes have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method, comprising:
storing data defining a user lifecycle phase and a desired outcome for the user lifecycle phase;
computing metrics for evaluating the effectiveness of each of a plurality of messages, the metrics comprising a lifecycle outcome metric and a message effectiveness metric for each of the plurality of messages;
generating a plurality of personalization rules based on the computed metrics and one or more attributes associated with a user, the personalization rules defining rules for selecting messages from the plurality of messages for presentation to the user; and
providing the plurality of personalization rules to a computing device associated with the user, wherein the computing device is configured to
select a message of the plurality of messages for presentation to the user using the personalization rules, and
present the selected message in a user interface.

2. The computer-implemented method of claim 1, wherein the lifecycle outcome metric defines a percentage of a group of users to which a message of the plurality of messages was shown and for which the desired outcome was achieved at the end of the user lifecycle phase.

3. The computer-implemented method of claim 1, wherein for each of the plurality of messages, the message effectiveness metric defines a number of times a message of the plurality of messages had to be presented to a user of the group of users to achieve a desired outcome for the message during the user lifecycle phase.

4. The computer-implemented method of claim 1, wherein the attributes comprise one or more of data describing a current user lifecycle phase for the user, data describing interests of the user, data describing utilization of an application by the user, data describing utilization of previous versions of the application by the user, or data describing interaction with messages presented to the user.

5. The computer-implemented method of claim 1, wherein the attributes are generated by collecting data from the user indicating interaction with an application and interaction with messages previously presented to the user by the application.

6. The computer-implemented method of claim 5, wherein the interaction with messages previously presented to the user comprises selecting the previous messages, ignoring the previous messages, deleting the previous messages, or using an application feature identified by the previous messages.

7. The computer-implemented method of claim 1, wherein the plurality of messages comprises messages specifying a user lifecycle phase the same as a user lifecycle phase associated with the user.

8. The computer-implemented method of claim 1, wherein the selected message comprises content identifying features of an application or content with instructions on the use of a feature of the application.

9. A computer-readable storage medium having computer-executable instructions stored thereupon which, when executed by a processor, cause the processor to:
store data defining a user lifecycle phase and a desired outcome for the user lifecycle phase;
compute metrics for evaluating the effectiveness of each of a plurality of messages, the metrics comprising
a lifecycle outcome metric for each of the plurality of messages, the lifecycle outcome metric defining a percentage of a group of users to which a message of the plurality of messages was shown and for which the desired outcome was achieved at the end of the user lifecycle phase, and
a message effectiveness metric for each of the plurality of messages, the message effectiveness metric defining a number of times a message of the plurality of messages had to be presented to a user of the group of users to achieve a desired outcome for the message during the user lifecycle phase;
generate a plurality of personalization rules based on the computed metrics and one or more attributes associated with a particular user, the personalization rules defining rules for selecting messages from the plurality of messages for presentation to the particular user; and
provide the plurality of personalization rules to a computing device, wherein the computing device is configured to
utilize the personalization rules to select a message of the plurality of messages for presentation to the particular user, and
present the selected message in a user interface.

10. The computer-readable storage medium of claim 9, wherein the attributes comprise one or more of data describing a current user lifecycle phase for the user, data describing interests of the user, data describing utilization of an application by the user, data describing utilization of previous versions of the application by the user, or data describing interaction with messages presented to the user.

11. The computer-readable storage medium of claim 9, wherein the attributes are generated by collecting data from the user indicating interaction with an application and interaction with messages previously presented to the user by the application.

12. The computer-readable storage medium of claim 11, wherein the interaction with messages previously presented to the user comprises selecting the previous messages, ignoring the previous messages, deleting the previous messages, or using an application feature identified by the previous messages.

13. The computer-readable storage medium of claim 9, wherein the plurality of messages comprises messages specifying a user lifecycle phase the same as a user lifecycle phase associated with the user.

14. The computer-readable storage medium of claim 9, wherein the selected message comprises content identifying features of an application or content with instructions on the use of a feature of the application.

15. A computing device, comprising:
a processor; and
a memory storing instructions executable by the processor to:
store data defining a user lifecycle phase and a desired outcome for the user lifecycle phase;
compute metrics for evaluating the effectiveness of each of a plurality of messages, the metrics comprising
a lifecycle outcome metric for each of the plurality of messages, the lifecycle outcome metric defining a percentage of a group of users to which a message of the plurality of messages was shown and for which the desired outcome was achieved at the end of the user lifecycle phase, and
a message effectiveness metric for each of the plurality of messages, the message effectiveness metric defining a number of times a message of the plurality of messages had to be presented to a user of the group of users to achieve a desired outcome for the message during the user lifecycle phase;
generate a plurality of personalization rules based on the computed metrics and one or more attributes associated with a particular user, the personalization rules defining rules for selecting messages from the plurality of messages for presentation to the particular user; and
provide the plurality of personalization rules to a second computing device, wherein the second computing device is configured to
utilize the personalization rules to select a message of the plurality of messages for presentation to the particular user, and
present the selected message.

16. The computing device of claim 15, wherein the attributes comprise one or more of data describing a current user lifecycle phase for the user, data describing interests of the user, data describing utilization of an application by the user, data describing utilization of previous versions of the application by the user, or data describing interaction with messages presented to the user.

17. The computing device of claim 15, wherein the attributes are generated by collecting data from the user indicating interaction with an application and interaction with messages previously presented to the user by the application.

18. The computing device of claim 17, wherein the interaction with messages previously presented to the user comprises selecting the previous messages, ignoring the previous messages, deleting the previous messages, or using an application feature identified by the previous messages.

19. The computing device of claim 15, wherein the plurality of messages comprises messages specifying a user lifecycle phase the same as a user lifecycle phase associated with the user.

20. The computing device of claim 15, wherein the selected message comprises content identifying features of an application or content with instructions on the use of a feature of the application.
